(19) United States
(12) Patent Application Publication
(10) Pub. No.: US 2021/0091361 A1
(43) Pub. Date: Mar. 25, 2021

(54) REUSABLE MODULAR SYSTEM FOR MAKING BATTERY PACKS IN SERIES AND PARALLEL CONFIGURATIONS

(71) Applicant: Aqora Limited, Dublin (IE)

(72) Inventors: Boris Gragera Moreno, Dublin (IE); Yeong Woo Kim, Timonium, MD (US)

(21) Appl. No.: 16/630,669

(22) PCT Filed: Jul. 16, 2018
(86) PCT No.: PCT/IB2018/055265

§ 371 Date: Jan. 13, 2020

Related U.S. Application Data
(60) Provisional application No. 62/532,602, filed on Jul. 14, 2017.

(51) Int. Cl. H01M 2/20; H01M 2/10

(52) U.S. Cl. CPC H01M 2/204; H01M 2/1094; H01M 2/105

(57) ABSTRACT

A battery pack system convertible among a series configuration, a parallel configuration, or both. The battery pack system includes a base component case having a housing configured to receive therein multiple batteries, and an expansion component case or a cap secured to the base component by a twist-and-lock feature. The battery pack system includes a positive conductor and a negative conductor running along an elongated interior of the base component case, and an insert composed of a dielectric and having a positive terminal and a negative terminal. The insert is configured to be inserted between adjacent batteries such that the positive terminal electrically connects to the positive conductor and the negative terminal electrically connects to the negative conductor to form a parallel-electrical connection between an adjacent battery pair, and such that, without the insert, an adjacent battery pair forms a series-electrical connection therebetween.

### CROSS-REFERENCE TO RELATED APPLICATION

This application claims priority to, and the benefit of, U.S. Provisional Patent Application Ser. No. 62/532,602, filed Jul. 14, 2017, entitled “REUSABLE MODULAR SYSTEM FOR MAKING BATTERY PACKS IN SERIES AND PARALLEL CONFIGURATIONS,” the contents of which are incorporated herein by reference in its entirety.

### FIELD OF THE INVENTION

The present disclosure relates to methods and systems for making battery packs in series and parallel configurations.

### BACKGROUND

External battery packs are used to power equipment across a range of different sectors from law enforcement to oil exploration, for example. Battery packs are required in different configurations, series and parallel. Series configurations increase the voltage, and parallel configurations increase the capacity. Sometimes battery packs are required to have a combination of series and parallel configurations. Battery packs are also required in different form factors. The most common form factors are tube (cylindrical batteries placed end to end) and side-by-side, when cylindrical batteries are placed side by side.

Especially with respect to non-rechargeable batteries, battery packs are used once and then discarded, which is needlessly wasteful and harmful to the environment. Most battery packs of this type are made using ultrasonic welding. The batteries are welded together in the desired configuration, are then protected from short circuit, leads are attached and the whole pack is covered in shrink wrap. To make it waterproof the pack can be dipped in rubber afterwards. When it is expended, everything is thrown away. It is an expensive, wasteful and time-consuming process.

Enclosures with integrated metal terminals have been developed for specific configurations whereby batteries can be dropped in, the enclosure is sealed and when the batteries are exhausted the enclosure can be reused after. This removes the need to weld batteries together, saves on waste and battery packs are easier to make. The main problem is that these systems are very inflexible. A separate enclosure is needed depending on configuration, number of batteries and form factor needed. In sectors like law enforcement where many different types of battery packs are needed, the enclosure model is impractical as too many different types would be necessary to cover their needs.

Because of this many sectors use disposable battery packs. They must estimate in advance what they need, they must control the stock and they must store the packs. There is a need for a flexible, easy-to-use system, whereby the battery pack user can buy their single batteries in bulk and assemble their packs in the configurations they want, as and when they need, without having to maintain numerous different enclosures to cover all possible configurations, or without needing to have expensive, wasteful and time consuming custom packs made by an external supplier.

### BRIEF SUMMARY OF THE VARIOUS EMBODIMENTS OF THE INVENTION

Aspects of the present disclosure are directed to an easy-to-use, reconfigurable, reusable and modular system for making battery packs. The system has one type of enclosure for making tube format battery packs and another for making side-by-side format battery packs.

The enclosure for each format takes advantage of a novel design of integrated terminals to allow the user to decide whether they want to make the battery pack in series or parallel configuration. The side-by-side format enclosure can easily be changed between parallel and series configurations by changing the cap. The tube format pack can easily be changed from series to parallel configurations by either dropping the batteries straight into the tube for series configuration or by inserting a specially designed conductive disk between each battery dropped into the tube for a parallel configuration.

The system is designed to be small, portable and lightweight. The enclosures are waterproof and can be fitted with a custom-designed valve to release pressure in the event of a battery malfunction without sacrificing the waterproof properties of the pack. The enclosures can also house a battery management system within their waterproof interior.

According to an aspect of the present disclosure, a battery pack system is disclosed that is convertible among a series configuration, a parallel configuration, or both. The battery pack system includes: a base component case having a housing configured to receive therein a plurality of batteries; an expansion component case or a cap secured to the base component by a twist-and-lock feature; a positive conductor and a negative conductor running along an elongated interior of the base component case; and an insert composed of a dielectric and having a positive terminal and a negative terminal. The insert is configured to be inserted between adjacent ones of the plurality of batteries such that the positive terminal electrically connects to the positive conductor and the negative terminal electrically connects to the negative conductor to form a parallel-electrical connection between the adjacent ones of the plurality of batteries, and such that without the insert the adjacent ones of the plurality of batteries form a series-electrical connection therebetween. Thus, it is contemplated by the present disclosure to have batteries connected inside the battery pack system all in series, in parallel, or some in series and some in parallel.

The expansion component case or the cap can include a positive conductor and a negative conductor running along an elongated interior of the base component case. The positive conductor of the expansion component case or the cap can mechanically and electrically connect to the positive conductor of the base component case when the twist-and-lock feature locks the base component case to the expansion component case or the cap. The negative conductor of the expansion component case or the cap can mechanically and electrically connect to the negative conductor of the base component case when the twist-and-lock feature is disengaged to release the base component case from the expansion component case or the cap.

The battery pack system can include an o-ring between the base component case and the expansion component case or the cap to form a waterproof seal therebetween. The o-ring can be seated around an exposed end of the base component case.

A length along the elongated interior of the housing can be dimensioned to be shorter than a total number of the plurality of batteries that can be inserted into the housing. The housing can have an opening from which the positive conductor and the negative conductor are exposed. The battery pack system can further include a layer of silicone below respective exposed surfaces of the positive conductor and the negative conductor to ensure a continuous and reliable electrical connection interface between (a) the positive conductor and the negative conductor of the base component case and (b) the positive conductor and the negative conductor of the expansion component case or the cap during heavy vibration.

The battery pack system can further include a plurality of magnets along an exterior of the housing and a magnet along an exterior of the expansion component case or the cap such that all of the magnets lie on the same plane to contribute to a continuous and reliable electrical connection interface between the base component case and the expansion component case or the cap. The positive terminal can include a battery mating surface that contacts a positive terminal of one of the batteries and the negative terminal can include a battery mating surface that contacts a negative terminal of an other one of the batteries.

The positive terminal of the insert can include a first spring portion that is spring-biased against the positive conductor responsive to the insert being positioned inside the housing, and the negative terminal of the insert can include a second spring portion that is spring-biased against the negative conductor responsive to the insert being positioned inside the housing.

A tool can be used to insert and remove the insert relative to the housing to convert the battery pack system between a series-electrical configuration and a parallel-electrical configuration. The tool includes: an elongated handle; and an insert coupling mechanism at an end of the elongated handle. The insert coupling mechanism includes a locking member that locks the mechanism to the insert by a rotational twist of the elongated handle relative to the mechanism. The insert can have a plurality of notches each having a different width from one another. The insert coupling mechanism can have a corresponding plurality of protrusions such that the notches of the insert can be received by the protrusions of the handle in one orientation only. The tool can include a detent that is configured to press against the locking member to cause it to be urged outwardly in a radial direction away from the handle, thereby creating a bias force against one of the plurality of notches sufficient to hold the insert against the tool even when both are held upside down relative to earth.

The insert can include a plurality of registration members, and the housing can include a plurality of corresponding grooves. The registration members of the insert ensure that a major surface of the insert maintains an orthogonal orientation relative to a bottom of the housing as the insert is introduced therein by pushing the tool and the insert until the insert is seated against the bottom of the housing or against a top of one of the plurality of batteries already present in the housing.

The batteries can be connected together according to at least one series configuration and at least one parallel configuration or at least two different series configurations and at least two different parallel configurations or at least three different series configurations and at least three different parallel configurations. The housing can be composed of a nylon or a carbon fiber.

According to another aspect of the present disclosure, a battery pack system convertible among a series configuration, a parallel configuration, or both. The battery pack system includes: a housing having an open end and a lid configured for the series configuration or the parallel configuration; and a plurality of exposed conductor spring terminals extending beyond the open end of the housing such that when the lid is secured onto the housing, the terminals become spring-biased to create a constant tension against corresponding conductors formed on an underside of the lid. A pattern of the conductors determines whether the lid is configured for the series configuration or for the parallel configuration.

The lid can be configured for the parallel configuration, in which the pattern of the conductors includes a first conductor pattern having a first section that electrically connects to two of the exposed conductor spring terminals and a pad that electrically connects to a third of the exposed conductor spring terminals, the pattern of conductors including a second conductor pattern having a plurality of first pads that connect to corresponding terminals of corresponding batteries present in the housing and a second pad that electrically connects to one of the exposed conductor spring terminals. Alternately, the lid can be configured for the series configuration, in which the pattern of conductors includes a first pad that electrically connects to a first of the exposed conductor spring terminals, a second pad that electrically connects to a second of the exposed conductor spring terminals, and a third pad that electrically connects to a third of the exposed conductor spring terminals, where two of the first, second, and third pads have an identical form.

The lid can be configured for both the series and the parallel configuration (called herein a hybrid configuration) such that at least a first pattern of conductors connects at least two batteries inside the housing in series and at least a second pattern of conductors connects at least two batteries or battery assemblies inside the housing in parallel. For example, at least two of the plurality of batteries can be connected together in series inside the housing and at least two others of the plurality of batteries can be connected together in parallel inside the housing.

### BRIEF DESCRIPTION OF THE DRAWINGS

A clear understanding of the key features summarized above may be had by reference to the appended drawings, which illustrate methods and systems of various aspects of the present disclosure, although it will be understood that such drawings depict exemplary embodiments and, therefore, are not to be considered as limiting its scope with regard to other contemplated embodiments. Accordingly:

FIG. 1 illustrates a battery pack system in a tube format in which three batteries are inserted end to end;

FIG. 2 illustrates another battery pack system also in a tube format that can accept two batteries;

FIG. 3 illustrates an exploded view of the battery pack system shown in FIG. 1;

FIG. 4 illustrates another exploded view of the battery pack system shown in FIG. 1;

FIG. 5 illustrates another exploded view of the battery pack system shown in FIG. 1, in which an o-ring is seated around the exposed end of the base component case;

FIG. 6 shows an end view from the exposed end of the base component case of the battery pack system shown in FIG. 1 or FIG. 2;

FIG. 7 illustrates part of the positive and negative conductors of the extension component case of the battery pack system shown in FIG. 1 or FIG. 2;

FIG. 8 illustrates disembodied positive and negative terminals and their corresponding exposed terminals of the battery pack system shown in FIG. 1 or FIG. 2;

FIG. 9 illustrates an inside view of the battery pack system where three batteries are installed inside, with the base component case secured with the extension component case via a twist-and-lock feature;

FIG. 10 illustrates a tool that can be used to convert between a series and parallel electrical circuit configuration quickly using one or more inserts 320, 322, which can be inserted and removed with the aid of the tool;

FIG. 11 illustrates an insert that can be inserted and removed with the aid of the tool shown in FIG. 10;

FIG. 12 illustrates the positive and negative terminals of the insert with the dielectric removed for ease of illustration;

FIG. 13 illustrates a spring portion 1208 bent to form a clip, to secure the terminal to the dielectric portion of the insert shown in FIG. 11;

FIG. 14 is an enlarged area of the insert shown in FIG. 11 illustrating the spring portion;

FIG. 15 illustrates an exploded view of the insert shown in FIG. 11 next to a tool shown in FIG. 10, in which a flat bent portion of the terminal slides into a slot formed along an outer edge of the insert;

FIG. 16 illustrates a detent integrally formed or attached at the base of the handle to rotate with the handle until the detent presses against a locking member;

FIG. 17 shows the detent shown in FIG. 16 pressing against the locking member to cause it to be urged outwardly in a radial direction away from the handle;

FIG. 18 illustrates a base component case featuring exposed terminals, which do not extend beyond corresponding dimensions of exposed end lips of corresponding threads of a twist-and-lock feature on the case;

FIG. 19 illustrates a twist-and-lock feature in which the base component case is twisted and locked relative to an expansion component case or cap/lid;

FIG. 20 a battery pack system in which the batteries are arranged in a side-by-side configuration inside a housing;

FIG. 21 shows the battery pack system of FIG. 20 with the housing rendered transparent to see four exposed conductor spring terminals that extend beyond an open end of the housing such that when a lid is secured over the o-ring, the terminals become spring-biased to create a constant tension against conductors on the underside of the lid;

FIG. 22 shows the four exposed conductor spring terminals extending beyond the open end of the housing of the battery pack system shown in FIG. 21;

FIG. 23 is a side view of the four exposed conductor spring terminals that jut beyond the open end of the housing;

FIG. 24 illustrates the conductor spring terminals and how they are connected inside the housing, with the housing removed for ease of illustration;

FIG. 25 illustrates a lid according to an embodiment, which enables a parallel-electrical configuration of the batteries;

FIG. 26 illustrates another lid according to another embodiment, which enables a series-electrical configuration of the batteries;

FIG. 27 illustrates a bottom view of a lid having conductor patterns arranged for a combined series and parallel battery connections inside the same four-battery pack housing; and

FIG. 28 illustrates a universal lid configured to accommodate multiple conductor patterns to convert the same lid among series, parallel, or hybrid configurations, without having to change the lid.

### DETAILED DESCRIPTION OF VARIOUS EMBODIMENTS OF THE INVENTION

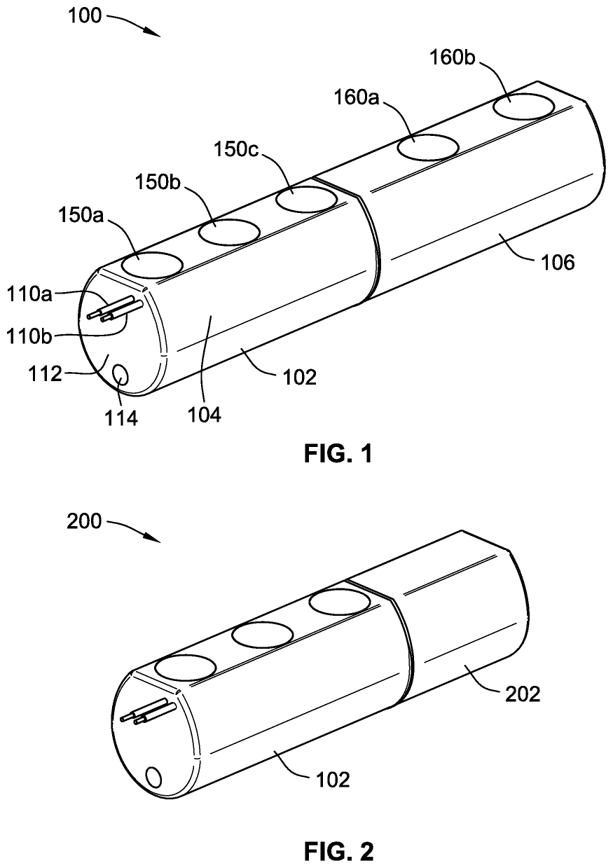

FIG. 1 illustrates a battery pack system 100 in a tube or generally tubular format or shape or form factor in which three batteries are inserted end to end. The battery pack system 100 includes a base component case 102, which has a housing 104. The modularity of the system 100 includes a twist-and-lock feature that allows either an expansion component case 106 or a cap or lid 202 (shown in FIG. 2) to be securely connected to the base component case 102. FIG. 2 illustrates another battery pack system 200 also in a tube format that can accept two batteries. Conventional positive and negative leads 110a, 110b exit an end 112 of the base component case 102. Silicone or other waterproofing material is used to seal the holes in the end 112 through which the leads 110a, 110b extend. A pressure relief valve 114 is incorporated into the end 112 to relieve pressure that can build up due to gas or heat inside the battery pack system 100 as a load is drawing power from the batteries. The entire battery pack system 100 is waterproof, and the housing 104 can be made of nylon, carbon fiber, or other materials that can withstand the internal heat generated by the batteries under load.

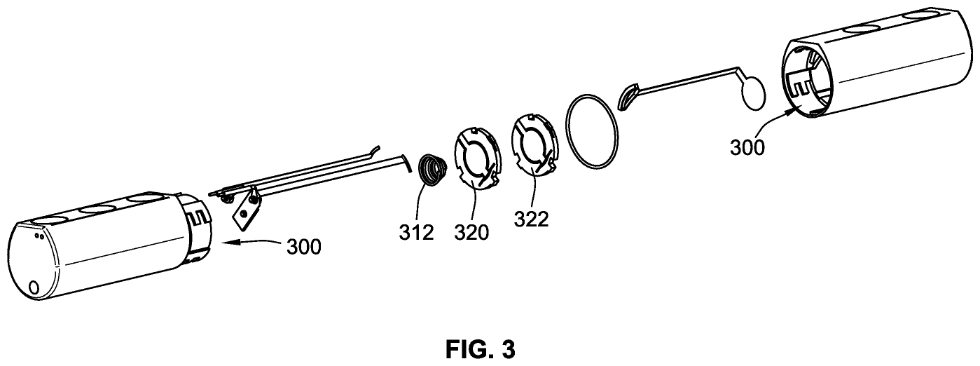

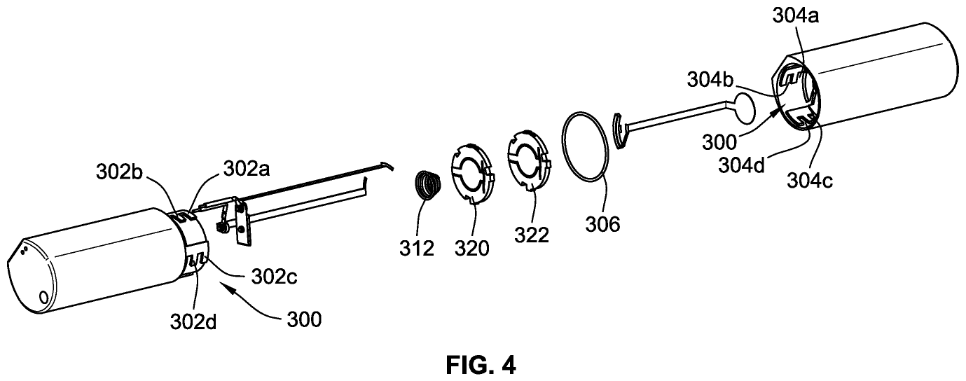

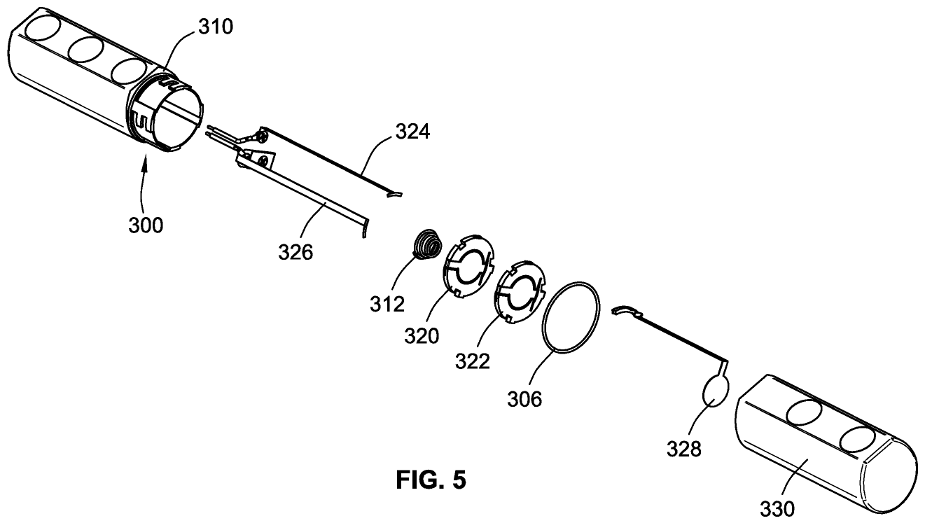

An exploded view of the battery pack system 100 is shown in FIG. 3. The twist-and-lock feature 300 includes two sets of a pair of threads 302a, 302b, 302c, 302d that are threadably received in corresponding grooves 304a, 304b, 304c, 304d in the component case 106 or the cap 202. An o-ring 306 is seated around the exposed end 310 (seen in FIG. 5) of the base component case 102. The o-ring creates a waterproof seal between the two cases 102, 106 or between the case 102 and the lid 202. A spring 312 is dimensioned to accommodate series-to-parallel conversion inserts 320, 322, which can optionally be inserted between batteries to convert the power configuration from a series to parallel configuration. The thickness of the inserts 320, 322 extend the total length of the batteries inside the cases 102, 106, and the spring 312 allows the total length to expand or contract depending on the number (0, 1, 2, or 3, for example) of inserts 320, 322 used in any particular configuration. A spring can also be present in the expansion component case 106 or in the lid 202, to accommodate part or all of the expansion of the total length due to the added thickness of the inserts 320, 322.

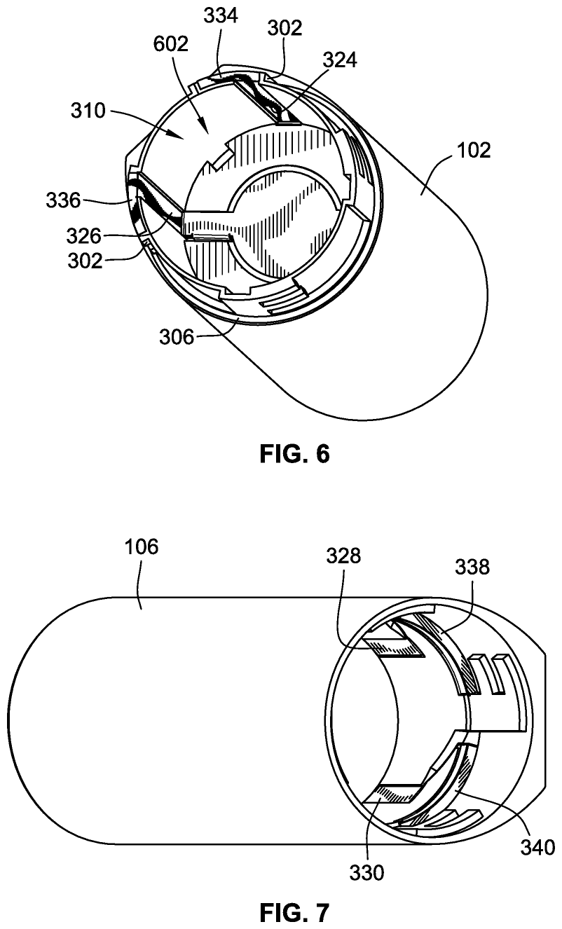

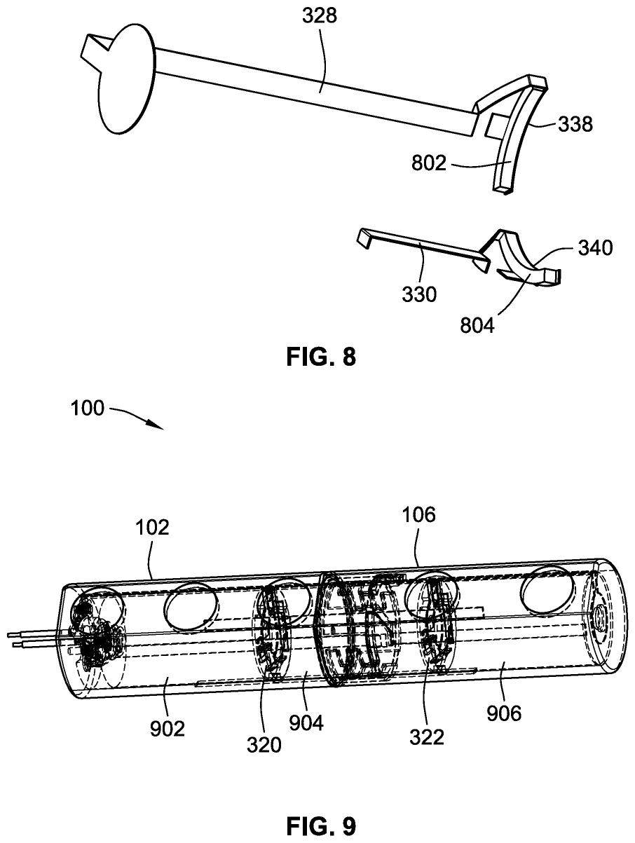

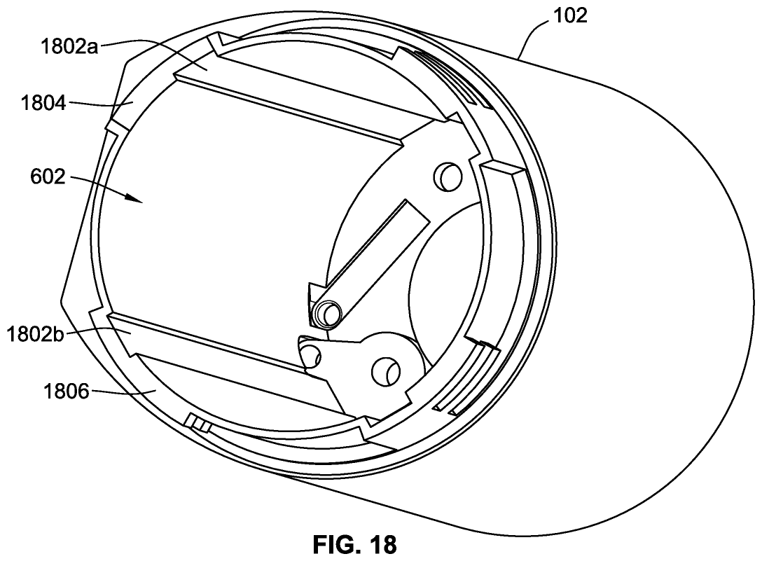

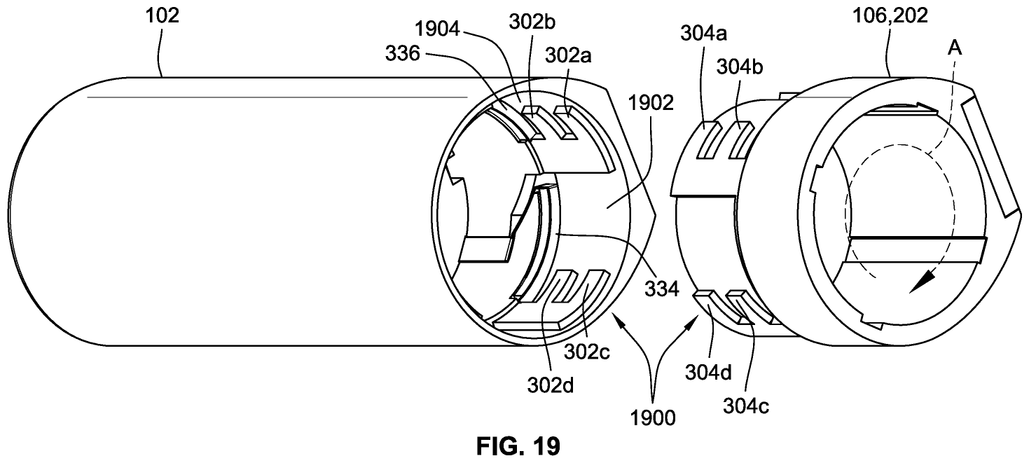

A positive conductor 324 and a negative conductor 326 are shown running along the elongated interior of the base component case 102, and a corresponding positive conductor 328 and negative conductor 330 run along the elongated interior of the extension component case 106. FIG. 6 shows an end view from the exposed end 310 of the base component case 102. Part of the positive and negative conductors 324, 326 can be seen, which are bent at their ends to form respective exposed positive and negative terminals 334, 336. The dimensions of the exposed terminals 334, 336 do not extend beyond corresponding dimensions of exposed end lips 1804, 1806 (FIG. 18) of the corresponding threads 302 of the twist-and-lock feature 1900 (FIG. 19) on the case 102. In this view, two additional sets of thread pairs can also be seen. In FIG. 7, part of the positive and negative conductors 328, 330 of the extension component case 106 can be seen, having respective exposed positive and negative terminals 338, 340. When the base component case 102 and the extension component case 106 are secured together by the twist-and-lock feature 1900, the exposed terminals 334, 336 of the base component case 102 make a physical and therefore electrical connection to the respective exposed terminals 338, 340 of the extension component case 106 (or the cap 202 if installed instead of the extension component case 106). In FIG. 8, only the positive and negative terminals 328, 330 and their corresponding exposed terminals 338, 340 are shown to illustrate another important feature of this disclosure. On the other side of the exposed terminals 338, 340, a 1 mm thick layer of silicone 802, 804, respectively, is applied to ensure a continuous electrical connection between the cases 102, 106 (or 202), especially during heavy vibration of the battery pack system 100. It was discovered that without this thin layer of silicone 802, 804, the electrical connections could become intermittently disconnected during vibrations, an undesirable result particularly for military or emergency response applications where it is essential to have a reliable power supply. Another feature that aids in ensuring a continuous and reliable electrical connection interface between the two separate cases 102, 106 is the optional magnets 150a, 150b, 150c on the base component case 102 shown in FIG. 1 and the optional magnets 160a, 160b on the extension component case 106. When the entire battery pack system 100 is magnetically secured to a flat magnetized surface, the magnets 150, 160 aid in keeping the two cases 102, 106 aligned during heavy vibrations or sudden shocks. The o-ring 306 also contributes to maintaining a reliable electrical connection, as well as the spring 312.

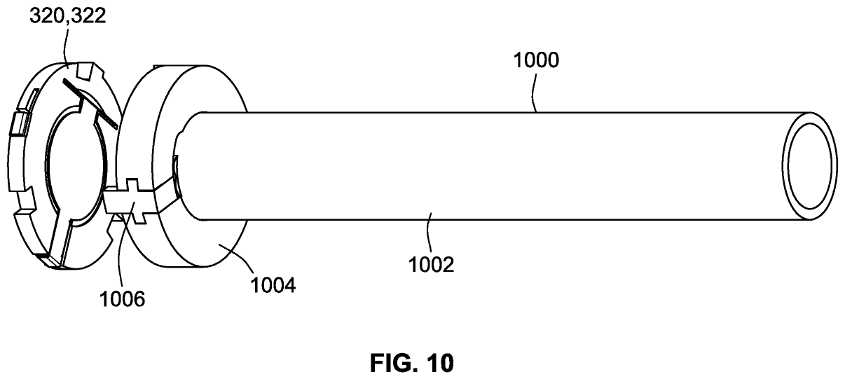

FIG. 9 illustrates an inside view of the battery pack system 100 where three (e.g., 3.6V) batteries 902, 904, 906 can be seen installed inside the battery pack system 100, with the base component case 102 secured with the extension component case 106 via the twist-and-lock feature 1900. In this configuration, the circuit arrangement of the batteries 902, 904, 906 is a parallel arrangement so that the voltage across the negative and positive is 3.6V in this example. An aspect of the present disclosure is the ability to convert between a series and parallel electrical circuit configuration quickly thanks to one or more inserts 320, 322, which can be inserted and removed with the aid of a tool 1000 shown in FIG. 10. The tool 1000 has an elongated handle 1002 terminating at an end thereof by an insert coupling mechanism 1004. The insert coupling mechanism 1004 is configured, as described below, to temporarily lock an insert 320, 322 so that it can be inserted into an open cavity 602 (seen in FIG. 6) of the case 102, 106, 202 and seated properly within the cavity 602. The insert coupling mechanism 1004 includes a locking member 1006 that locks the mechanism 1004 to the insert 320, 322 as described below by a simple rotational twist of the handle 1002 relative to the mechanism 1004.

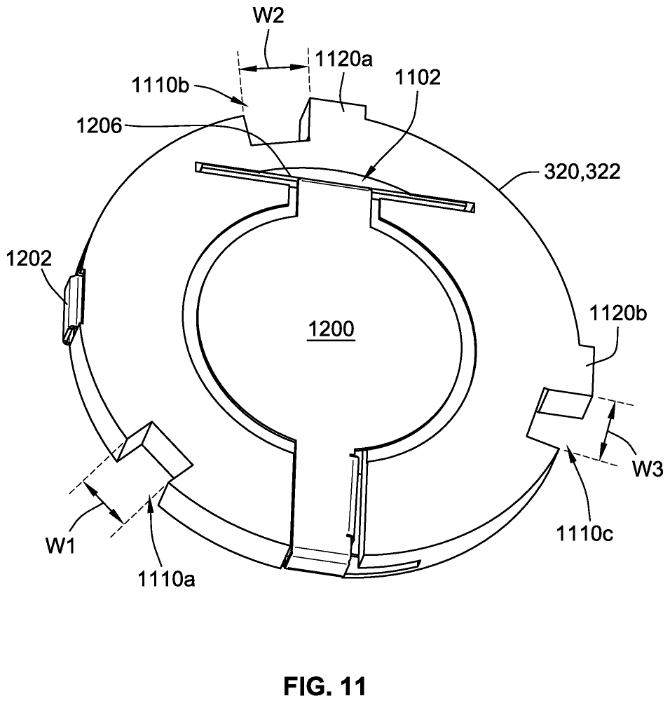

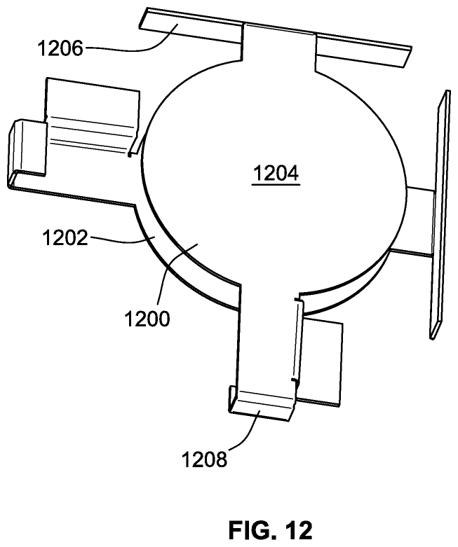

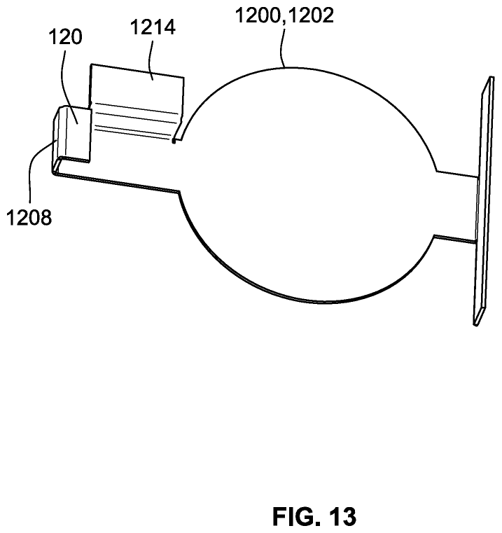

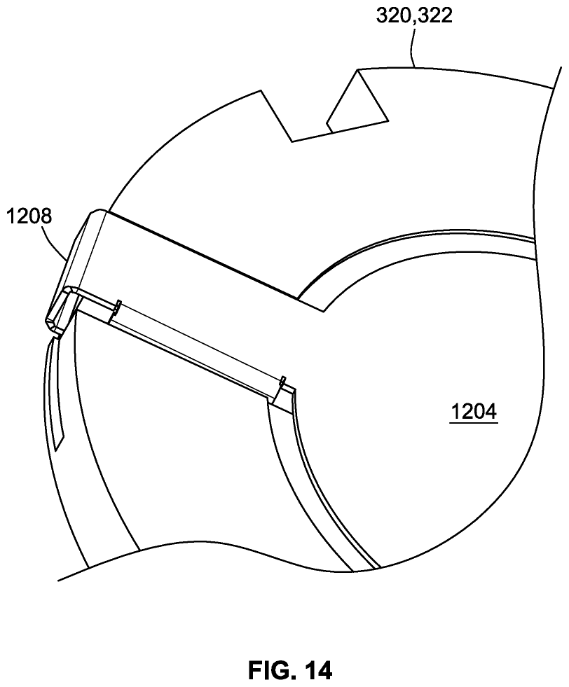

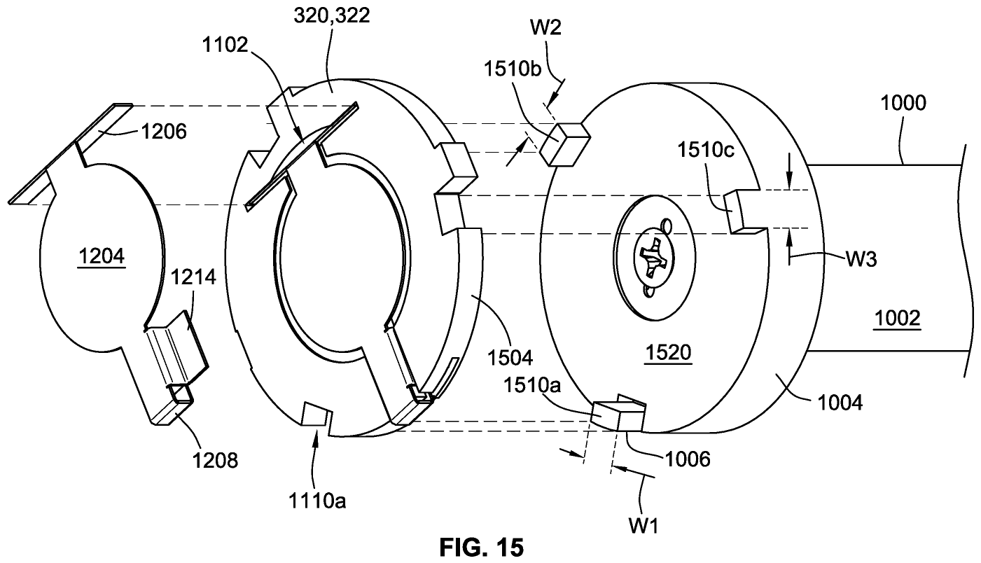

The insert 320, 322 is made of a dielectric (non-conducting) material, such as nylon, plastic, or the like, and includes on both sides of the disk-shaped insert 320, 322 a corresponding negative terminal 1200 and a positive terminal 1202, seen best in FIG. 12 where the dielectric material has been removed for ease of illustration. Both terminals 1200, 1202 are identical, but are juxtaposed at orthogonal orientations relative to one another as seen in FIG. 12 on opposite sides of the disk-shaped insert 320, 322. The negative terminal 1200 connects the negative terminal of one of the batteries 902, 904, 906 to the corresponding negative conductor 326, 330 in the case 102 or 106 as the case may be. Likewise, the positive terminal 1202 connects the positive terminal of another of the batteries 902, 904, 906 to the corresponding positive conductor 324, 328 in the case 102 or 106 as the case may be. Each terminal has a battery mating surface 1204 leading on one side to a bent portion 1206, which is bent orthogonally relative to the surface 1204 and inserted into a slot 1102, best seen in FIG. 11. The other end of the battery mating surface 1204 leads to a bent spring portion 1208, which protrudes slightly from the outer perimeter of the insert 320, 322, which makes a physical and therefore electrical connection to the corresponding conductor 324, 326, 328, 330 in the case 102 or 106. The spring portion 1208 acts like a spring, which is forced inwardly toward the insert 320, 322 when the insert 320, 322 is inserted into a cavity 602 (FIG. 6) of the case 102 or 106. The terminal 1200, 1202 can also include another flat bent portion 1214, which as can be seen in FIG. 15, slides into a slot 1502 formed along an outer edge 1504 of the insert 320, 322. The spring portion 1208 is bent to form a clip, best seen in FIG. 13, where a bottom leg 1210 of the spring portion 1208 serves, together with the bent portion 1206 on the opposite side of the mating surface 1204 and the flat bent portion 1214, to secure the terminal 1200, 1202 to the dielectric portion of the insert 320, 322.

Returning to FIG. 11, the insert includes notches 1110a, 1110b, 1110c, three in this example, having different widths, W1, W2, W3, respectively. As can be seen in FIG. 15, these widths W1, W2, W3 correspond to the respective widths of protrusions 1510a, 15110b, 1510c shown in FIG. 15. In this way, the insert 320, 322 can be mated flush against the bottom 1520 of the mechanism 1004 of the tool 1000 in one orientation only. While the notches 1110 and protrusions 1510 can be spaced equidistantly apart (e.g., 120 degrees when there are three), in other implementations, they can be spaced at different distances force registration of the insert 320, 322 relative to the bottom 1520 in only one orientation.

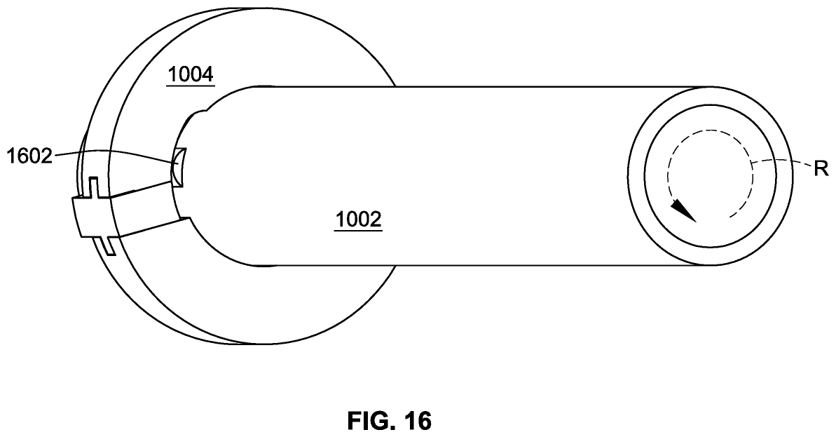

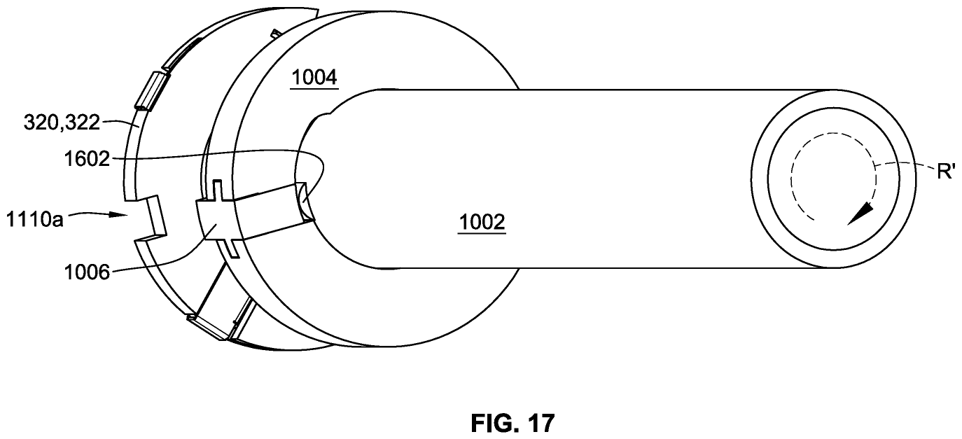

However, it is not enough to simply orient the insert 320, 322 in the one and only correct orientation relative to the protrusions 1510. The tool 1000 is used to convert the battery system 100 from a series configuration to a parallel configuration, sometimes by holding the insert upside 320, 322 down, which would otherwise cause it to succumb to gravity and fall away from the tool 1000. To allow the insert 320, 322 to be inserted in any orientation (between horizontal and vertical, relative to earth, and any orientation in between), a locking member 1006 can cause one of the notches 1510a to hold the insert 320, 322 securely against the bottom 1520 even when orientated upside-down relative to the direction of gravity. To lock the locking member 1006, the handle 1002 of the tool 1000 is rotated slightly, as can be seen in FIGS. 16 and 17, described next.

In FIG. 16, a detent 1602 is integrally formed or attached at the base of the handle 1002 such that when the handle 1002 is rotated in a direction R relative to the mechanism 1004, the detent 1602 also rotates until it reaches the position shown in FIG. 17, which causes the detent 1602 to press against the locking member 1006, thereby causing the locking member 1006 to be urged outwardly in a radial direction away from the handle 1002. The notch 1510a is correspondingly urged slightly inwardly, creating a bias force against the notch 1110a of the insert 320, 322. This bias force is sufficient to hold the entire insert 320, 322 against the tool 1000, even when the tool 1000 and insert 320, 322 are both held upside down relative to earth.

The insert 320, 322 also includes registration members 1120a, 1120b (FIG. 11), which slide along corresponding grooves 1802a, 1802b (FIG. 18), respectively, in the case 102, 106, or lid 202. The registration members 1120a, 1120b ensure that the major surface of the insert 320, 322 maintains an orthogonal orientation relative to the bottom of the cavity 602 as the insert 320, 322 is introduced therein by pushing the tool 1000, together with the insert 320, 322, locked thereto via the locking member 1006, until the insert 320, 322 is seated either against the bottom of the cavity 602 or against the top of a battery 902, 904, 906 inserted into the cavity 602. To unlock the tool 1000 from the insert 320, 322, the operator twists the handle 1002 in an opposite direction R′ shown in FIG. 17, which in turn rotates the detent 1602 to release the bias force against the locking member 1006, thereby causing the locking member 1006 to release its tension against the insert 320, 322. The tool 1000 sans the insert 320, 322 can now be removed from the cavity 602 while leaving the insert 320, 322 in situ inside the case 102, 106, 202.

Using the tool 1000 to install and remove inserts 320, 322, any number of series and parallel battery configurations are possible, including configurations having batteries connected in series and other batteries connected in parallel in the same battery system. For example, if each battery is 3.6V, the following non-exhaustive battery pack configurations are possible by utilizing expansion cases like the case 106, a lid 202, and/or one or more inserts 320, 322 and a base 102 (where a “+” sign symbolizes a series electrical connection between adjacent batteries and a “|” symbolizes a parallel electrical connection among adjacent batteries, where an insert would be present):

battery=3.6V

battery+battery=7.2V

battery+battery+battery=10.8V

battery+battery+battery+battery=14.4V

battery|battery=3.6V, 2 cell

battery+battery|battery+battery=7.2V, 2 cell (this is an example of a “hybrid” series and parallel configuration in the same battery pack system)

battery|battery|battery=3.6V, 3 cell

battery|battery|battery|battery=3.6V, 4 cell

Of course, the battery voltage can vary, but these are just a few examples of the many battery and voltage configurations possible with the modular battery pack system of the present disclosure. It should be understood that any voltage combination and any combination of series or parallel connections or all series or all parallel configurations are explicitly contemplated by the present disclosure.

To connect the base 102 to another expansion case 106 or a lid 202, the case/lid 106, 202 is oriented as shown in FIG. 19 so that the threads 304 of the case/lid 106, 202 align with corresponding channels 1902, 1904 (the other two channels are obscured in FIG. 19, as are two other sets of threads 304 on the case/lid 106, 202), until the o-ring 306, the exposed terminals 334, 336 on the base 102, and the exposed terminals 338, 340 on the case 106 (if present) come together, and then the case/lid 106, 202 is rotated in a direction A shown in FIG. 19 until the sets of threads 302, 304 interlock.

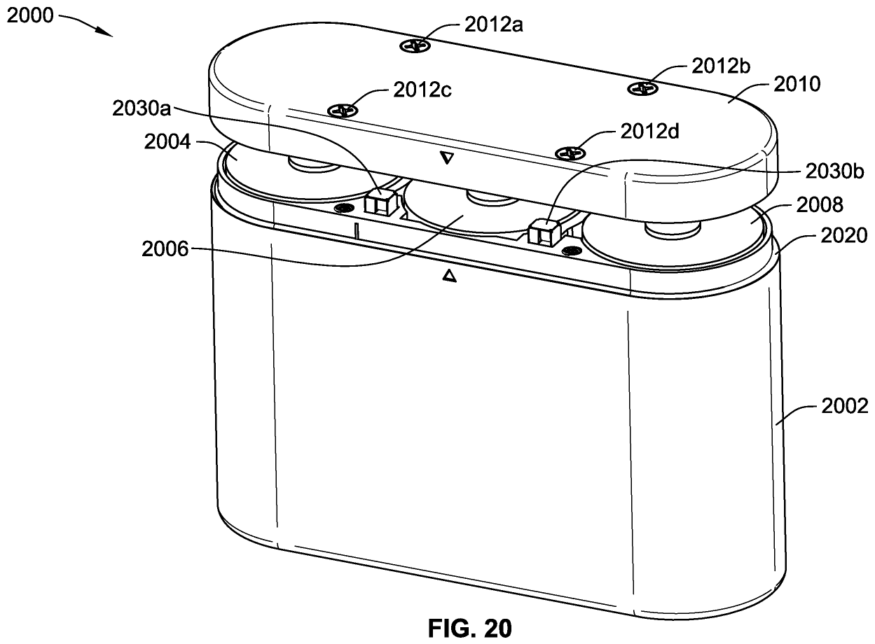

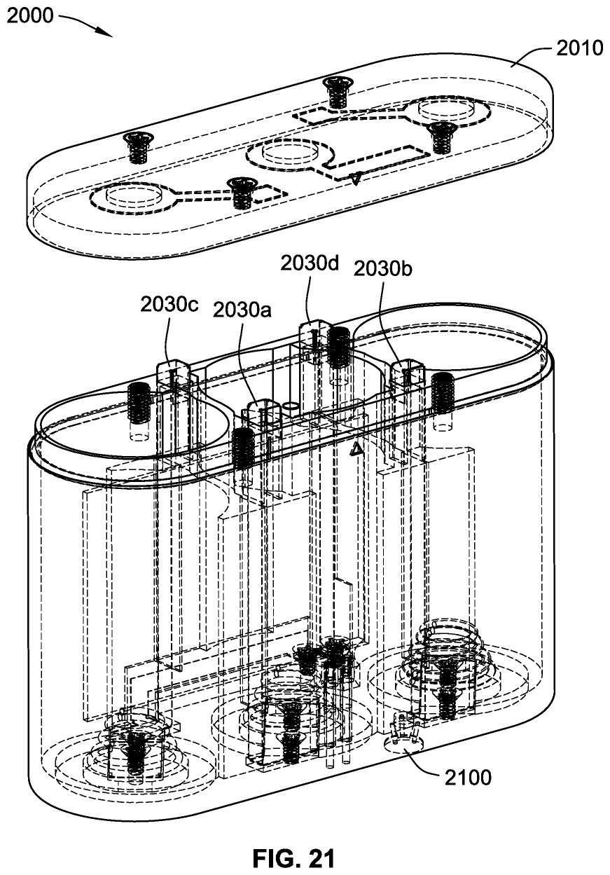

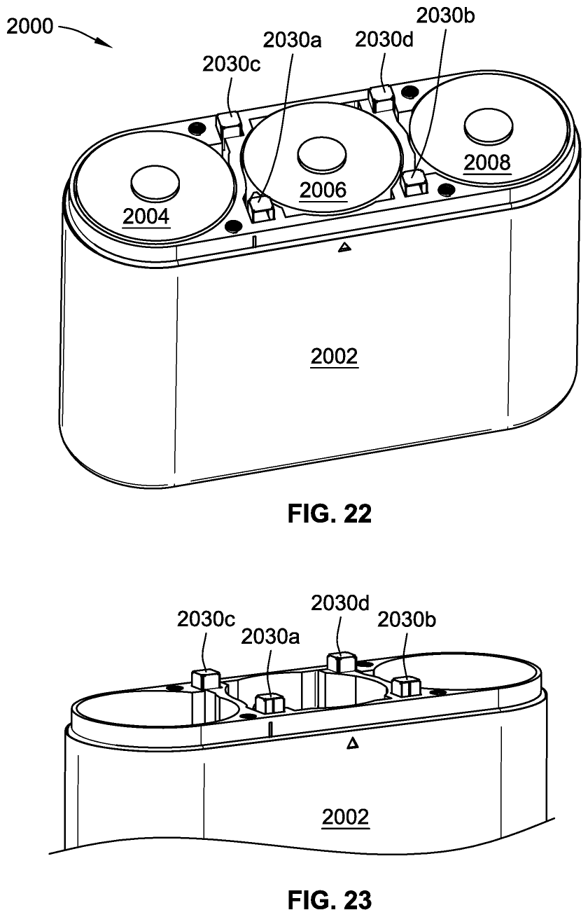

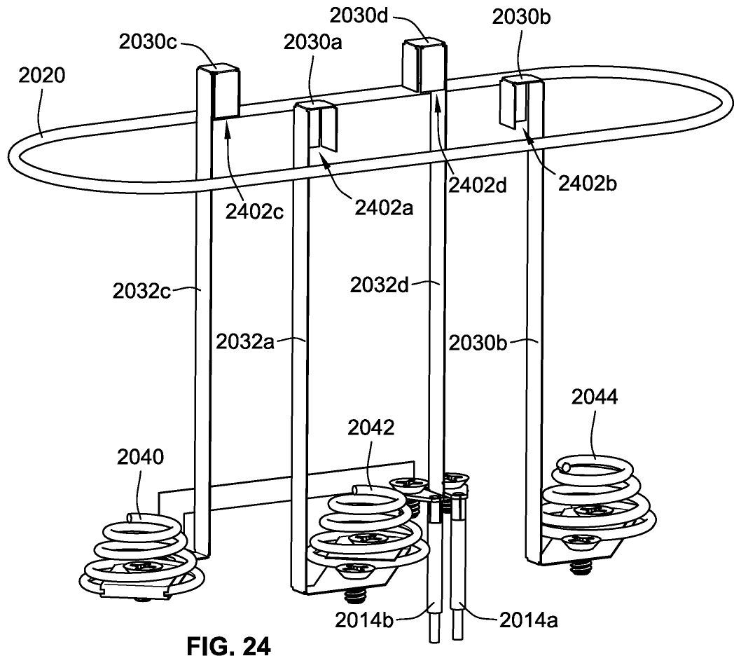

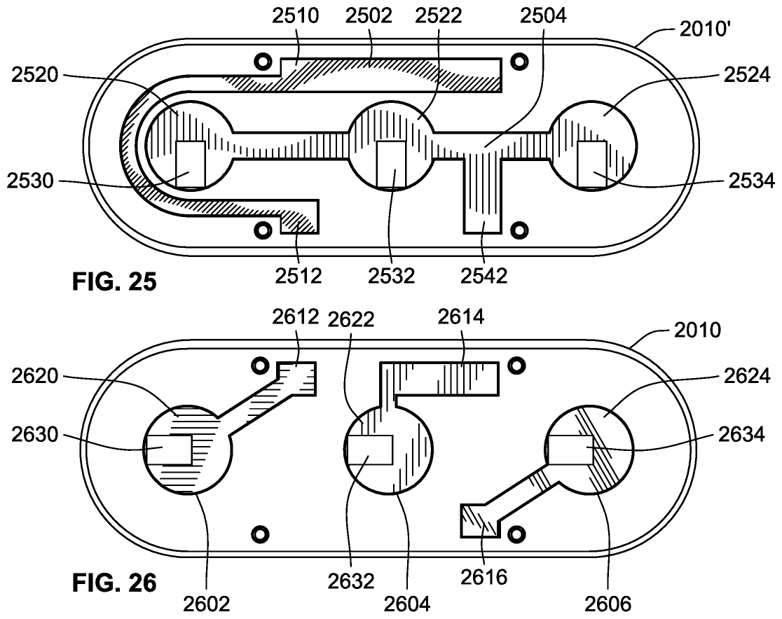

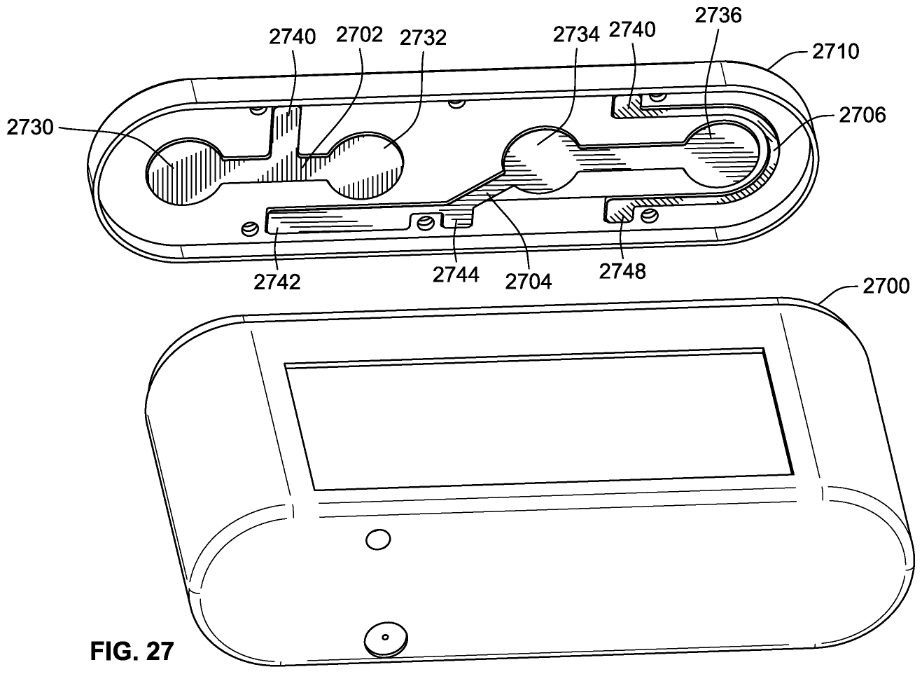

FIG. 20 illustrates another form factor for a battery pack system 2000 according to another aspect of the present disclosure, in which the batteries 2004, 2006, 2008 are arranged in a side-by-side configuration inside a housing 2002. The housing 2002 is capped by a lid 2010, which is screwed onto the housing via screws 2012a,b,c,d. Negative and positive leads 2014a, 2014b exit the housing 2002 via holes in a bottom end thereof, where the holes can be plugged with silicone or other waterproofing material to prevent water impingement inside the housing 2002. An o-ring 2020 (best seen in FIG. 24) encircles the housing 2002 at an interface between the housing 2002 and the lid 2010 to make a watertight and moisture barrier at the interface. Exposed conductor spring terminals 2030a,b,c,d (all four can be seen in FIG. 21) extend beyond the open end of the housing 2002 such that when the lid 2010 is secured over the o-ring 2020, the terminals 2030a,b,c,d become spring-biased to create a constant tension against conductors (described below) on the underside of the lid 2010. Like the battery pack system 100, the battery pack system 2000 is convertible between a series and parallel configuration, in this embodiment simply by changing the lid 2010. FIG. 21 shows a lid 2010 that enables a series configuration of the batteries 2004, 2006, 2008, whereas FIG. 25 illustrates a lid 2010′ that enables a parallel configuration of the batteries 2004, 2006, 2008. Although the housing 2002 is shown as accommodating three batteries, of course as few as two or four (see FIG. 27) or five or six or seven or eight or more batteries are contemplated by simply adjusting the size of the housing and corresponding lid in accordance with the present disclosure.

FIG. 24 illustrates the terminal connections inside the housing 2002, with the housing 2002 removed for ease of illustration. The position of the o-ring 2020 can be seen, with the exposed terminals 2030a,b,c,d extending above the o-ring 2020. The exposed terminals 2030a,b,c,d lead to respective conductors 2032a,b,c,d. Conductors 2030c and 2030d are physically and electrically connected together, and connect to a spring 2040 and to the positive lead 2014b that exits the housing 2002. The conductor 2032a connects to a spring 2042, and the conductor 2032b connects to a spring 2044. The conductor 2032d is connected to the negative lead 2014a that exits the housing 2002.

FIGS. 25 and 26 illustrate parallel and series configurations of the lid 2010′, 2010, respectively. The parallel configuration of the lid 2010′ shown in FIG. 25 includes two conductor patterns 2502, 2504. The first conductor pattern 2502 includes a first section 2510 that electrically connects to the exposed spring terminals 2030c,d, and a pad 2512 that electrically connects to the exposed spring terminal 2030a when the lid 2010′ is secured onto the housing 2002. The second conductor pattern 2504 includes three circular pads 2520, 2522, 2524 that connect to the negative terminals of the batteries 2004, 2006, 2008. Optionally the circular pads 2520, 2522, 2524 can include bent tabs 2530, 2532, 2534 that aid in ensuring that a continuous electrical contact exists between the second conductor pattern 2504 and the negative terminals of the batteries 2004, 2006, 2008, even during heavy vibration of the battery pack system 2000. The second conductor pattern 2504 includes a pad 2542 that electrically connects to the exposed spring terminal 2030b.

The series configuration of the lid 2010 shown in FIG. 26 includes three conductor patterns 2602, 2604, 2606, which can also be seen in FIG. 21. Each of the conductor patterns 2602, 2604, 2606 includes a respective circular pad 2620, 2622, 2624, which can optionally include a bent tab 2630, 2632, 2634 to facilitate a continuous electrical connection to the negative terminals of the batteries 2004, 2006, 2008. The first conductor pattern 2602 also includes a pad 2612 that electrically connects to the exposed spring terminal 2030a in the housing 2002 when the lid 2002 is secured thereon. The second conductor pattern 2604 includes a pad 2614 that electrically connects to the exposed spring terminal 2030b, and the third conductor pattern 2606 includes a pad 2616 that electrically connects to the exposed spring terminal 2030d. No electrical connection is made between the lid 2010 and the exposed spring terminal 2030c in this series configuration. The first conductor pattern 2602 and the third conductor pattern 2606 are identical so only two types of conductor patterns need to be constructed for the series-style lids 2010. Likewise, only two types of conductor patterns need to be constructed for the parallel-style lids 2010′, reducing the number of parts that are required to be made to accommodate both series and parallel configurations for the same housing 2002.

Referring to FIG. 24, underneath each of the exposed terminals 2030a,b,c,d, there is a corresponding space 2402a,b,c,d. Optionally, a spring can be installed within each of these spaces 2402a,b,c,d, which biases the respective exposed terminals 2030a,b,c,d outwardly so that they maintain a positive bias force against the conductors in the lid 2010, 2010′ at all times, and return to their unbiased position when the lid 2010, 2010′ is removed.

FIG. 27 illustrates a bottom view of a lid 2710 having conductor patterns arranged for a combined series and parallel battery connections inside the same battery pack housing 2700 like the housing 2002, except in FIG. 27, the housing is configured to accept four batteries. For example, in the case of four batteries, each of which has the same voltage and capacity, it would be possible to connect all four batteries in series, or in parallel, or two batteries in series and two batteries in parallel inside the housing 2700 by attaching the lid 2710 to the housing 2700 as described above in connection with FIG. 20. The combined series and parallel configuration will be called a hybrid configuration herein, which means that in the same battery pack housing, batteries can be connected in both series and parallel electrical configurations. Thus, the hybrid configuration of the lid 2070 shown in FIG. 27 includes three conductor patterns 2702, 2704, 2706. Two batteries whose terminals contact the conductor pattern 2702 are connected in series, and two batteries whose terminals contact the conductor patterns 2704, 2706 are connected in parallel, where all four batteries reside inside the same battery pack housing. The first conductor pattern 2702 includes circular pads 2730, 2732 that connect to corresponding terminals (such as the negative terminals) of two of the batteries in the housing, and the second conductor pattern 2704 includes two circular pads 2734, 2736 that connect to corresponding terminals (such as the negative terminals) of two other batteries in the housing 2700.

The first conductor pattern 2702 includes a pad 2740, the second conductor pattern 2704 includes pads 2742, 2744, and the third conductor pattern 2706 includes pads 2746, 2748. These pads 2740, 2742, 2744, 2746, 2748 connect to five corresponding exposed conductor spring terminals like the spring terminals 2030a,b,c,d shown in FIG. 20. In FIG. 20, the housing accommodates three batteries, but in the embodiment shown in FIG. 27, the housing 2700 accommodates four batteries, so an additional pair of exposed conductor spring terminals are present as will be appreciated by those skilled in the art. The area opposite the conductor spring terminal 2744 is unused in this hybrid configuration. The spring terminals in the housing 2700 are connected in a manner as taught in connection with FIG. 24 so that the multiple series, parallel, and hybrid configurations are achievable by simply changing the conductor patterns or swapping out the lids 2010, 2010′, 2700.

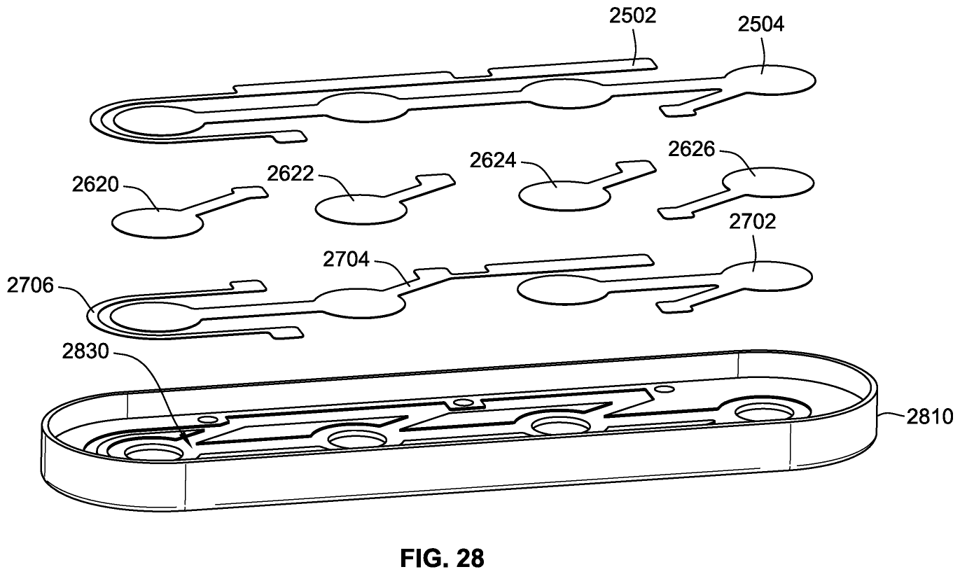

FIG. 28 illustrates a universal lid 2800 that is configured to accommodate multiple conductor patterns to convert the same lid 2800 among series, parallel, or hybrid configurations, without having to change the lid 2800. Instead, different sets of conductor patterns are installed into corresponding recesses or grooves 2830 formed in the bottom of the lid, preferably in a way that permits only one orientation of the conductor patterns to be installed. For example, to configure the lid 2800 for a hybrid configuration, the conductor patterns 2702, 2704, 2706 are installed into the corresponding recesses 2830 in the lid 2800. To change the configuration, the conductor patterns 2702, 2704, 2706 are removed, and the conductor patterns 2620, 2622, 2624, 2626 can be installed into the corresponding recesses 2830 in the lid 2800.

1. A battery pack system convertible among a series configuration, a parallel configuration, or both, the battery pack system comprising:
a base component case having a housing configured to receive therein a plurality of batteries;
an expansion component case or a cap secured to the base component by a twist-and-lock feature;
a positive conductor and a negative conductor running along an elongated interior of the base component case;
an insert composed of a dielectric and having a positive terminal and a negative terminal, wherein the insert is configured to be inserted between adjacent ones of the plurality of batteries such that the positive terminal electrically connects to the positive conductor and the negative terminal electrically connects to the negative conductor to form a parallel-electrical connection between the adjacent ones of the plurality of batteries, and such that without the insert the adjacent ones of the plurality of batteries form a series-electrical connection therebetween.

2. The battery pack system of claim 1, wherein the expansion component case or the cap includes a positive conductor and a negative conductor running along an elongated interior of the base component case, wherein the positive conductor of the expansion component case or the cap mechanically and electrically connects to the positive conductor of the base component case when the twist-and-lock feature locks the base component case to the expansion component case or the cap, and wherein the negative conductor of the expansion component case or the cap mechanically and electrically connects to the negative conductor of the base component case when the twist-and-lock feature is disengaged to release the base component case from the expansion component case or the cap.

3. The battery pack system of claim 1, further comprising an o-ring between the base component case and the expansion component case or the cap to form a waterproof seal therebetween.

4. The battery pack system of claim 3, wherein the o-ring is seated around an exposed end of the base component case.

5. The battery pack system of claim 1, wherein a length along the elongated interior of the housing is dimensioned to be shorter than a total number of the plurality of batteries that can be inserted into the housing.

6. The battery pack system of claim 2, wherein the housing has an opening from which the positive conductor and the negative conductor are exposed, the battery pack system further comprising a layer of silicone below respective exposed surfaces of the positive conductor and the negative conductor to ensure a continuous and reliable electrical connection interface between (a) the positive conductor and the negative conductor of the base component case and (b) the positive conductor and the negative conductor of the expansion component case or the cap during heavy vibration.

7. The battery pack system of claim 2, further comprising a plurality of magnets along an exterior of the housing and a magnet along an exterior of the expansion component case or the cap such that all of the magnets lie on the same plane to contribute to a continuous and reliable electrical connection interface between the base component case and the expansion component case or the cap.

8. The battery pack system of claim 1, wherein the positive terminal includes a battery mating surface that contacts a positive terminal of one of the batteries and the negative terminal includes a battery mating surface that contacts a negative terminal of an other one of the batteries.

9. The battery pack system of claim 1, wherein the positive terminal of the insert includes a first spring portion that is spring-biased against the positive conductor responsive to the insert being positioned inside the housing, and the negative terminal of the insert includes a second spring portion that is spring-biased against the negative conductor responsive to the insert being positioned inside the housing.

10. The battery pack system of claim 1, in combination with a tool used to insert and remove the insert relative to the housing to convert the battery pack system between a series-electrical configuration and a parallel-electrical configuration, the tool comprising:
an elongated handle;
an insert coupling mechanism at an end of the elongated handle, the insert coupling mechanism including a locking member that locks the mechanism to the insert by a rotational twist of the elongated handle relative to the mechanism.

11. The battery pack system of claim 10, the insert having a plurality of notches each having a different width from one another, and the insert coupling mechanism having a corresponding plurality of protrusions such that the notches of the insert can be received by the protrusions of the handle in one orientation only.

12. The battery pack system of claim 10, the tool further comprising a detent that is configured to press against the locking member to cause it to be urged outwardly in a radial direction away from the handle, thereby creating a bias force against one of the plurality of notches sufficient to hold the insert against the tool even when both are held upside down relative to earth.

13. The battery pack system of claim 10, the insert including a plurality of registration members, the housing including a plurality of corresponding grooves, wherein the registration members of the insert ensures that a major surface of the insert maintains an orthogonal orientation relative to a bottom of the housing as the insert is introduced therein by pushing the tool and the insert until the insert is seated against the bottom of the housing or against a top of one of the plurality of batteries already present in the housing.

14. The battery pack system of claim 1, wherein the plurality of batteries can be connected together according to at least one series configuration and at least one parallel configuration or at least two different series configurations and at least two different parallel configurations or at least three different series configurations and at least three different parallel configurations.

15. The battery pack system of claim 1, wherein the housing is composed of a nylon or a carbon fiber.

16. A battery pack system convertible among a series configuration, a parallel configuration, or both, the battery pack system comprising:
a housing having an open end and a lid configured for the series configuration or the parallel configuration or both;
a plurality of exposed conductor spring terminals extending beyond the open end of the housing such that when the lid is secured onto the housing, the terminals become spring-biased to create a constant tension against corresponding conductors formed on an underside of the lid, wherein a pattern of the conductors determines whether the lid is configured for the series configuration, for the parallel configuration, or for both.

17. The battery pack system of claim 16, wherein the lid is configured for the parallel configuration, in which the pattern of the conductors includes a first conductor pattern having a first section that electrically connects to two of the exposed conductor spring terminals and a pad that electrically connects to a third of the exposed conductor spring terminals, the pattern of conductors including a second conductor pattern having a plurality of first pads that connect to corresponding terminals of corresponding batteries present in the housing and a second pad that electrically connects to one of the exposed conductor spring terminals.

18. The battery pack system of claim 16, wherein the lid is configured for the series configuration, in which the pattern of conductors includes a first pad that electrically connects to a first of the exposed conductor spring terminals, a second pad that electrically connects to a second of the exposed conductor spring terminals, and a third pad that electrically connects to a third of the exposed conductor spring terminals, where two of the first, second, and third pads have an identical form.

19. The battery pack system of claim 16, wherein the lid is configured for both the series and the parallel configuration such that at least a first pattern of conductors connects at least two batteries inside the housing in series and at least a second pattern of conductors connects at least two batteries or battery assemblies inside the housing in parallel.

20. The battery pack system of claim 1 in which at least two of the plurality of batteries are connected together in series inside the housing and at least two others of the plurality of batteries are connected together in parallel inside the housing.
